(19) United States
(12) Patent Application Publication
(10) Pub. No.: US 2011/0249127 A1
(43) Pub. Date: Oct. 13, 2011

(54) Estimating Video Quality Corruption in Lossy Networks

(75) Inventors: Rui Zhang, Pleasanton, CA (US); Jim Chen Chou, San Jose, CA (US); Tapabrata Biswas, Sunnydale, CA (US)

(73) Assignee: CISCO TECHNOLOGY, INC., San Jose, CA (US)

(21) Appl. No.: 12/755,684

(22) Filed: Apr. 7, 2010

(51) Int. Cl. H04N 17/00

(52) U.S. Cl. 348/192; 348/E17.003

(57) ABSTRACT

Techniques are provided herein for estimating video quality corruption at a device in a network from a data stream encapsulating a video transport stream comprising one or more video frames. The video transport stream is decoded to produce a current video frame. A current loss affected region map is generated comprising values configured to indicate a level of quality for each macroblock in the current video frame, and a decoder based or deterministic quality corruption metric is generated based on the values in the current loss affected region map. When the network device does not have video decoding capability, techniques are further provided for computing a statistics-based video quality corruption metric based on a data loss rate for the current video frame and other statistics.

### TECHNICAL FIELD

The present disclosure relates generally to estimating video quality, and more specifically to estimating a metric that is a measure of video quality corruption.

### BACKGROUND

Multimedia traffic is ever increasing on most networks including lossy networks, such as Internet Protocol (IP) networks. When video is transmitted over a lossy network, packet loss can produce noticeable unwanted audio and video effects. To compensate for data loss, error control techniques including forward error correction, error concealment, error resilience, and retransmission may be employed. To reduce the effects of error propagation due to data loss, intra macroblock updates and long term reference pictures may also be used.

When transmitting data in lossy networks it is often necessary to collect statistics related to multimedia delivery, e.g., quality of service metrics. There are two types of video quality metrics. One type of quality metric is reference based, meaning that the original video source is available for comparison. The other type of quality metric is non-reference based, meaning that the original video source is not available for comparison. For non-reference based video quality metrics, it is difficult to have a pixel-based non-reference quality metric because a measure has not been found that can universally define “good” quality video. As a result, pixel-based quality metrics are limited to detecting specific artifacts such as blocking and blurring artifacts. When loss effect is considered, the video quality metric is generally represented through or translated from network layer statistics, such as packet loss rate, jitter, and delay. The characteristics of the video itself are not considered.

### BRIEF DESCRIPTION OF THE DRAWINGS

FIG. 1 is block diagram showing an example of a multimedia network with various network devices that are configured to generate a quality corruption metric.

FIGS. 2a and 2b are example block diagrams of network devices that are configured to generate quality corruption metrics according to the techniques described herein.

FIG. 3 is a diagram showing an example of an activity region map for a video frame that depicts active regions having motion and static regions with relatively little or no motion.

FIG. 4 is a diagram showing an example of a loss affected region map for a video frame that depicts data loss in active regions and data loss in static regions.

FIG. 5 is a diagram showing an example of a loss affected region map for a video frame that depicts data error propagation in active and static regions.

FIG. 6 is a diagram showing an example of a loss affected region map for a video frame that depicts intra macroblock updates in the active region.

FIG. 7 is an example of a flowchart generally depicting the process for generating a quality corruption metric for decoded video.

FIG. 8 is an example of a flowchart depicting a specific example of a process for generating a quality corruption metric for decoded video.

FIG. 9 is an example of a flowchart generally depicting a process for generating a quality corruption metric for video based on statistical analysis of the associated data stream.

FIG. 10 is an example of a flowchart depicting a specific example of a process for generating a quality corruption metric for video based on statistical analysis of the associated data stream.

### DESCRIPTION OF EXAMPLE EMBODIMENTS

Overview

Techniques are provided herein for receiving at a device in a network, a data stream encapsulating a video transport stream comprising one or more video frames. The video transport stream is decoded to produce a current video frame. A current loss affected region map is generated comprising values configured to indicate a level of quality for each macroblock in the current video frame. A decoder based or deterministic quality corruption metric is generated for the video transport stream based on the values in the current loss affected region map.

When the network device does not have video decoding capability, techniques are further provided for generating a data loss rate for the current video frame based on information contained in the data stream. A first statistical ratio is computed that consists of an active number of pixels of the current video frame to a total number of pixels of the current video frame, and a second statistical ratio is computed that consists of a number of pixels of the current video frame that have an error propagated from a reference video frame to a number of pixels of a reference video frame that have been lost or have propagated error. The quality corruption metric is computed as an arithmetic combination of the data loss rate, the first statistical ratio, and the second statistical ratio.

The Motion Pictures Expert Group (MPEG) video encoding standards provide a high degree of compression by encoding blocks of pixels (macroblocks) using various techniques and then using motion compensation to encode most video frames (or slices) as predictions from or between other frames. In particular, an encoded MPEG video stream is comprised of a series of a group of pictures (GOPs) or group of blocks, and each GOP begins with an independently encoded I-frame (INTRA-coded frame) and may include one or more following INTER-coded frames, such as P-frames (predictive-coded frame) or B-frames (bi-directionally predictive-coded frame). Each I-frame can be decoded independently and without additional information. Decoding of a P-frame requires information from a preceding frame in the GOP. Decoding of a B-frame requires information from a preceding and a following frame in the GOP. Because B and P-Frames can be decoded using information from other frames they require less bandwidth when transmitted.

Embodiments disclosed herein are generally described with respect to an encoder and a decoder that conform to at least some parts of the International Telecommunications Union (ITU) H.264 Recommendation (MPEG-4 Part 10). It should be understood that the techniques described herein, however are not restricted to H.264, and can be used for any temporally coded video, e.g., H.263 and VC-1. The techniques are also generally described with respect to whole frames. It should be understood that the techniques described herein may be applied to partial frames such as a group of blocks or slices, i.e., spatially separated portions of a frame or picture.

### Example Embodiments

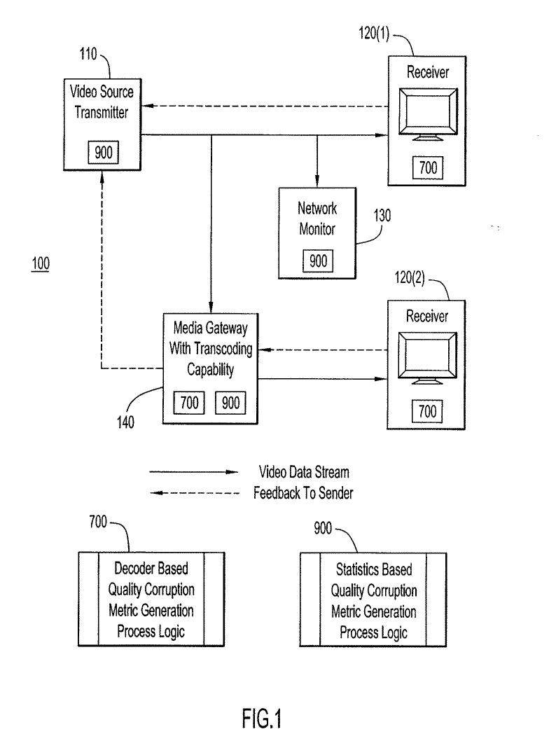

Referring first to FIG. 1, a block diagram showing an example of an Internet Protocol (IP) network 100 with various nodes or network devices that are configured to generate a quality corruption metric (QCM) is shown. The network 100 has a video source transmitter 110, and one or more video receivers 120(1) and 120(2). Network 100 may optionally have one or more network monitors, e.g., network monitor 130, and one or more media gateways with transcoding capability, e.g., media gateway 140. It should be appreciated that network 100 may have numerous other video transmitters and receivers, as well as other networking components, e.g., network routers and switches.

In network 100, video is transmitted from video transmitter 110 to video receivers 120(1) and 120(2) shown by the solid arrows. The transmitted video could be video from a video conference, an instant messaging session, IP television, or any other video content, and the like. The video may be transmitted in a transport stream encoded according to a known video standard, e.g., H.264 or MPEG-2. The transport stream is encapsulated for transport over IP network 100 using a protocol such as Real-time Transport Protocol (RTP) that ensures timely delivery of the video to each receiver. Feedback is provided over the network 100 and is shown by the dashed arrows.

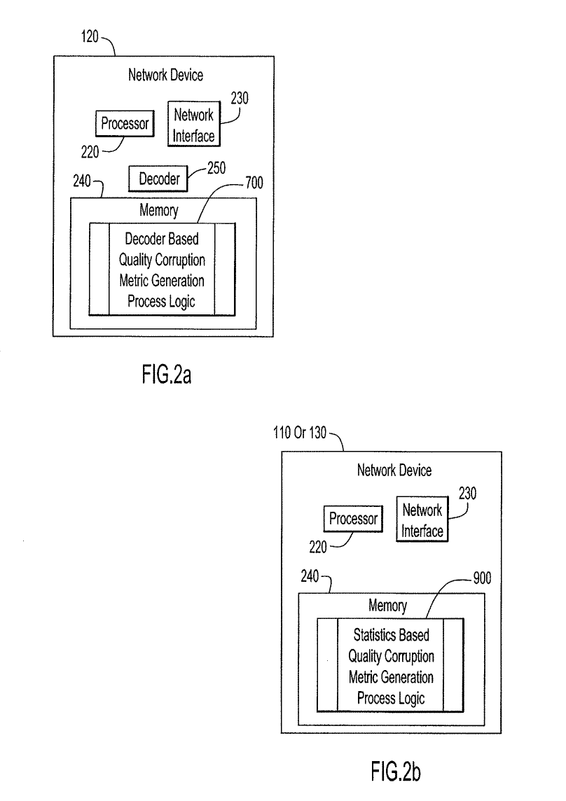

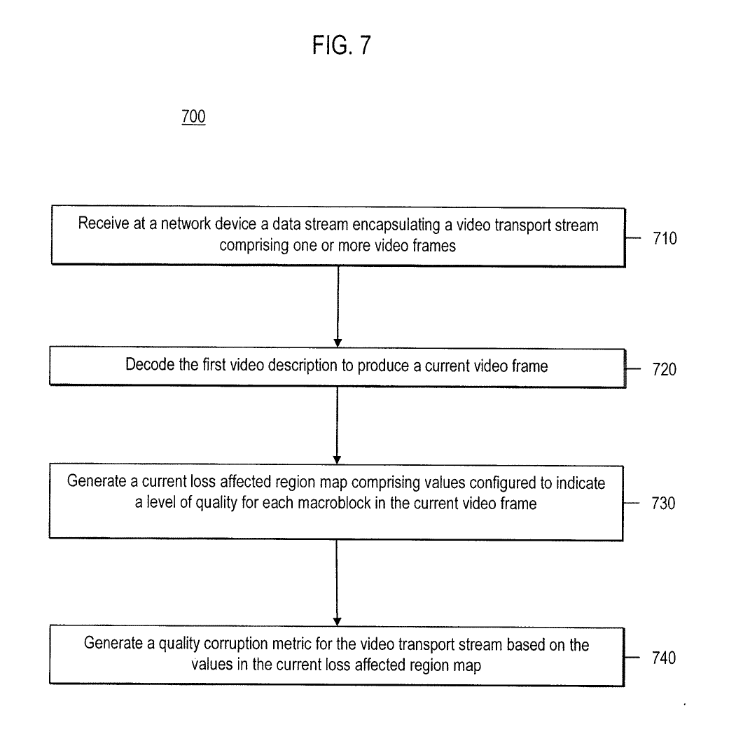

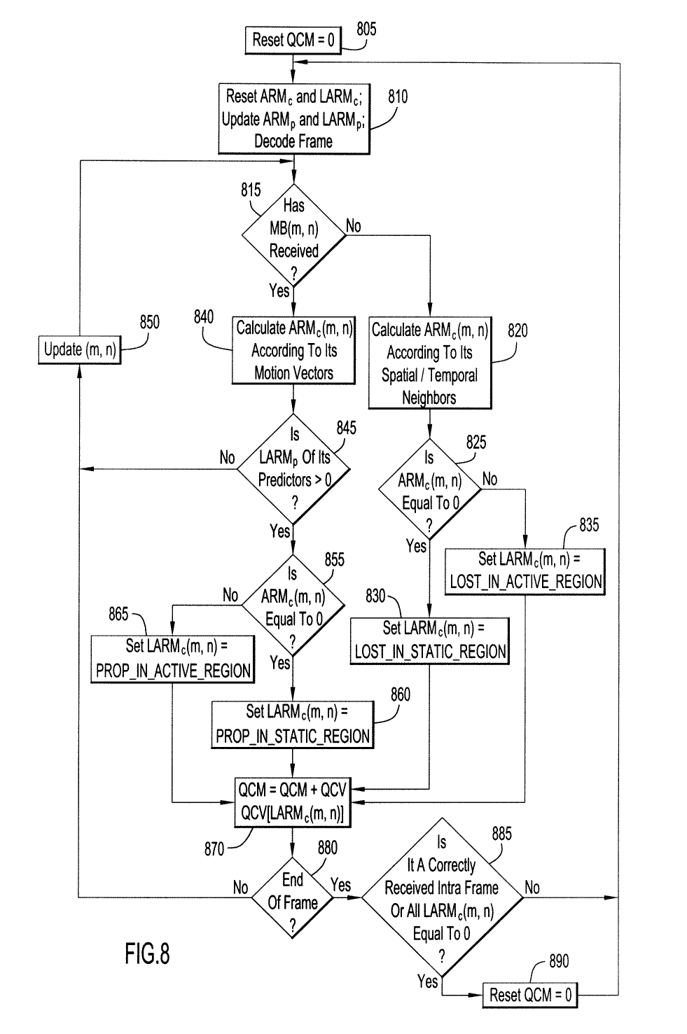

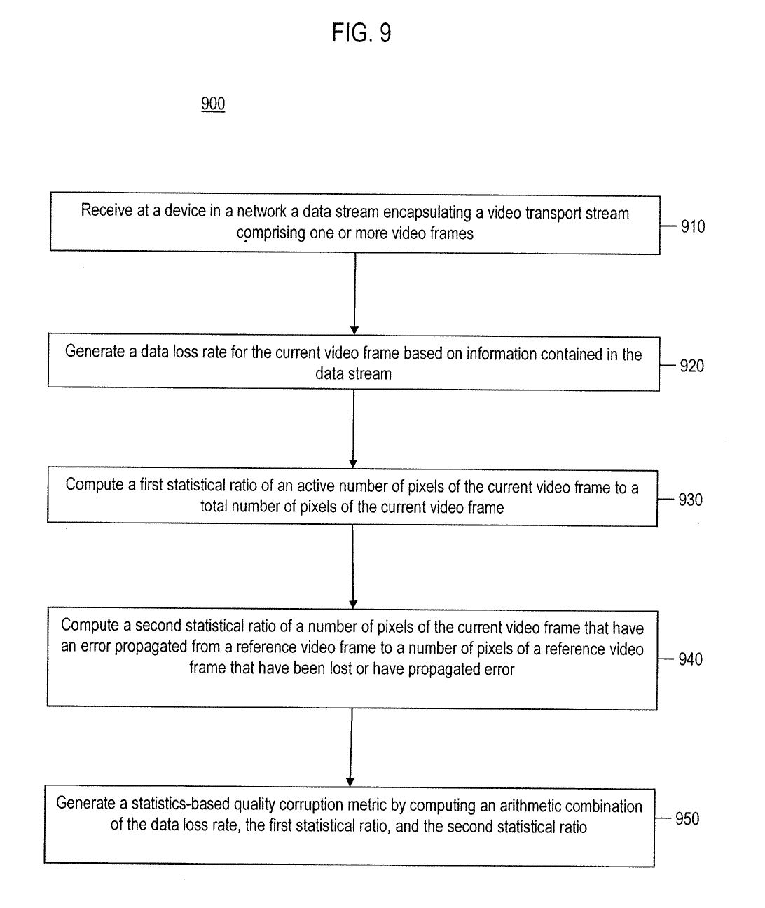

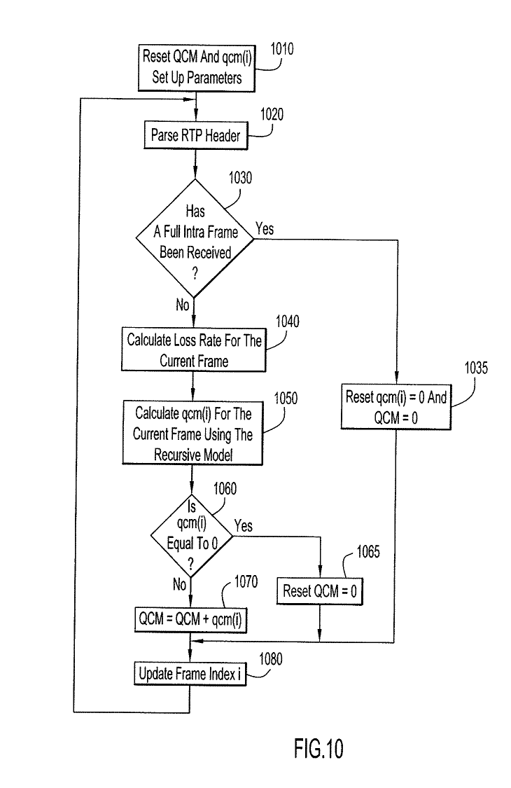

Network 100 is considered to be a lossy network in which data is corrupted or lost during transmission from the video source to the video receiver. In this regard, each of the devices in network 100 is configured to generate a non-reference based QCM using decoder based QCM generation process logic 700, statistics-based QCM generation process logic 900, or both, as shown. The QCM may be based on decoded video or based on certain network statistics, as will be described hereinafter. Process logic 700 will be generally described in connection with FIGS. 1, 2a, 3, 4, 5, and 6, and described in greater detail in connection with FIGS. 7 and 8, and process logic 900 will be generally described in connection with FIGS. 1, and 2b, and described in greater detail in connection with FIGS. 9 and 10.

For example, devices with decoding capability, e.g., media gateway 140 and video receivers 120(1) and 120(2), can generate a deterministic QCM based on decoded video, while devices without decoding capability, e.g., video transmitter 110 and network monitor 130, can generate a statistical QCM based on network statistics, hereinafter also referred to as a statistics-based QCM. Media gateway 140 can generate both types of QCMs, e.g., a decoder based QCM for video received from video transmitter 110, and statistics-based QCM using feedback received from receiver 120(2) or from received RTP packets encapsulating video from video transmitter 110. For simplicity, both video transmission and feedback are shown in a unidirectional manner, and it should be understood that both video and feedback may be generated at any device in network 100, e.g., video may be transmitted from video receiver 120(2) to video transmitter 110 so that both parties may hold a video teleconference.

Referring to FIG. 2a, an example block diagram of a network device configured to perform or execute the decoder based QCM generation process logic 700, e.g., video receiver 120, is shown. Video receiver 120 comprises a processor 220, a network interface unit 230, a memory 240, and a decoder 250. Video receiver 120 is configured perform or the QCM process logic 100 to generate QCMs using decoder based QCM generation process logic 700. The network interface unit 230 enables communication between the video receiver 120 and other network elements in the network 100, such as by way of wired, wireless, or optical interfaces. The memory 240 stores instructions for the decoder based QCM generation process logic 700. The decoder based QCM generation process logic 700 generates the QCM using video decoded by the decoder 250. The decoder 250 may be separate or part of the processor 220, e.g., an off-chip or on-chip hardware accelerator.

The processor 220 is a data processing device, e.g., a microprocessor, microcontroller, systems on a chip (SOCs), or other fixed or programmable logic. The processor 220 interfaces with the memory 240 that may be any form of random access memory (RAM) or other data storage block that stores data used for the techniques described herein. The memory 240 may be separate or part of the processor 220. Instructions for performing the decoder based QCM generation process logic 700 may be stored in the memory 240 for execution by the processor 220.

The functions of the processor 220 may be implemented by a processor readable tangible medium encoded with instructions or by logic encoded in one or more tangible media (e.g., embedded logic such as an application specific integrated circuit (ASIC), digital signal processor (DSP) instructions, software that is executed by a processor, etc.), wherein the memory 240 stores data used for the computations or functions described herein (and/or to store software or processor instructions that are executed to carry out the computations or functions described herein). Thus, the process 700 may be implemented with fixed logic or programmable logic (e.g., software/computer instructions executed by a processor or field programmable gate array (FPGA)), or the processor readable tangible medium may be encoded with instructions that, when executed by a processor, cause the processor to execute the process 700.

Referring to FIG. 2b, an example block diagram of relevant portions of a second network device, e.g., video network monitor 130 or sender video source device 110, is shown. This device comprises a processor 220, a network interface unit 230, a memory 240, but lacks software or hardware decoding capability. The processor 220, the network interface unit 230, and memory 240 may be configured to operate as described in connection with FIG. 2a for video receiver 120. The device shown in FIG. 2b is configured to generate statistics-based QCMs using statistics-based QCM generation process logic 900. The memory 240 stores instructions for the statistics-based QCM generation process logic 900. The statistics-based QCM generation process logic 900 generates the QCM using information contained in packets received over the network 100.

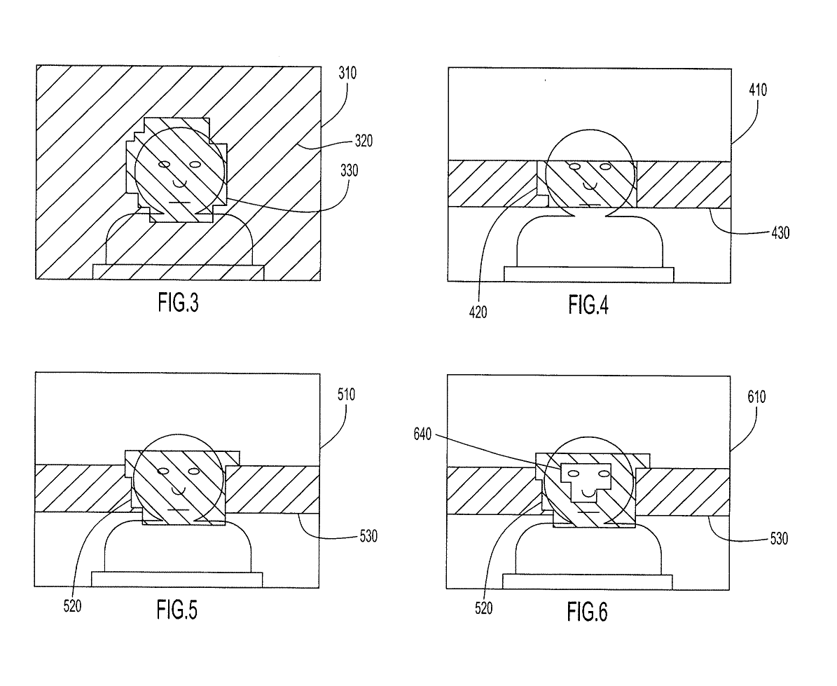

Turning now to FIGS. 3-6, a series of maps will be described with respect to an example video frame. The maps are generated from decoded video frames and are provided to aid in explaining the decoder based QCM generation process logic 700 that will be described in conjunction with FIG. 7. FIG. 3 depicts a decoded video frame 310 that has been divided into active and static regions, i.e., an activity region map (ARM). The video frame 310 is composed of an X×Y matrix of macroblocks. Each macroblock comprises a matrix of video pixels that may be divided into sub-blocks, e.g., 4×4 pixels, 4×8 pixels, 16×16 pixels, or other known dimensions. Each macroblock may have an associated level of motion from one video frame to the next represented by a motion compensation vector.

Video frame 310 depicts a speaker in front of a blank background while the camera itself is not moving. In this example, parts of the speaker's face and head will move as he speaks, i.e., parts of the speaker's face and head will be active as indicated by hatching that proceeds from the upper left to lower right, while the background remains relatively still, i.e., static as indicated by hatching that proceeds from the upper right to lower left. For ease of illustration, the background hatching has been removed from FIGS. 4-6. Thus, the active region 330 is shown for macroblocks that make up the construction worker's head and the static region 320 primarily covers the background. The ARM may be represented as an X×Y array or set of values stored in memory. Each individual macroblock (MB) in the array may be indexed by m, n, i.e., MB(m, n) refers to an individual macroblock within the X×Y array. For example, each macroblock in the static region may be assigned a value of zero and each macroblock in the active region could be assigned a value of one within the ARM. In other examples, each macroblock in the ARM could be assigned a value relative to its associated motion vector, e.g., the magnitude of the associated motion vector. An ARM for a current video frame, i.e., one that is currently being decoded, may be designated ARM_{c}, while an ARM for a previous frame, reference frame or picture, or a picture that is being predicted from may be designated ARMₚ.

Referring to FIG. 4, with continued reference to FIG. 3, a loss affected region map (LARM) is shown for a decoded video frame 410. In this example, the video stream has been affected by loss when it was transmitted over the network. When referring to “loss”, as described herein, “loss” generally means lost data, lost macroblocks, or other loss in video stream, and may also refer to loss that is propagated to video frames predicted from other frames that have experienced data loss. Decoded frame 410 depicts three regions including an unaffected region with no data loss indicated by a lack of hatching, a data loss region 430 within an active region that corresponds to the active region shown in FIG. 3, and a data loss region 420 within a static region that corresponds to the static region shown in FIG. 3. When a lost macroblock is detected, the ARM is consulted to determine if the loss occurred in the active or static regions. The LARM may be stored in memory as an array or set of values. For example, each macroblock in the unaffected region may be assigned a value of zero in the LARM and each lost macroblock in the active and static regions are assigned enumerated values in the LARM, e.g., LOST_IN_ACTIVE_REGION and LOST_IN_STATIC_REGION as will be described hereinafter. A LARM for a current video frame may be designated LARM_{c} and a LARM for a previous frame may be designated LARMₚ. Note that more than one ARMₚ and LARMₚ may be stored in memory if more than one reference picture is available, e.g., H.264 allows for multiple reference frames.

Referring to FIG. 5, a LARM is shown with error propagation for a decoded video frame 510 that uses macroblocks predicted from a decoded video frame, e.g., decoded video frame 410. Decoded frame 510 depicts three regions including an unaffected region with no data loss or loss-propagation indicated with no hatching, a data loss-propagated region 530 within the active region, and a data loss-propagated region 520 within the static region. Note that in this map the data loss-propagated region 530 in the active region is larger than the data loss region 430 depicted in decoded video frame 410 from FIG. 4. The area of error in the active region may also shift or move from frame to frame. This is due to the fact that macroblocks in frame 510 have motion (motion vectors) relative to the macroblocks in frame 410 from which they were predicted. When a loss-propagated macroblock is detected, the ARM is consulted to determine if the propagation occurred in the active or static regions. Each macroblock in the unaffected region may be assigned a value of zero in the LARM and each loss-propagated macroblock in the active and static regions can be assigned enumerated values, e.g., PROP_IN_ACTIVE_REGION and PROP_IN_STATIC_REGION.

Referring to FIG. 6, at 610, a LARM that has been updated by an intra macroblock update is shown. In this example, the LARM from FIG. 5 has updated macroblocks 640 from the encoder within the active region 530. The data loss region 520 remains unchanged. Updated macroblocks may be sent by the encoder in response to feedback from the decoder or they may be sent in a known sequence or pattern. By updating the macroblocks, video quality can be improved. This is shown by a lack of hatching in updated region 640. The QCM can be adjusted to account for the intra macroblock updates.

Turning now to FIG. 7, a flowchart generally depicting the decoder based QCM generation process logic 700 will now be described. At 710, at a device in a network, a data stream encapsulating a video transport stream comprising one or more video frames is received. At 720, the video transport stream is decoded to produce a current video frame. At 730, a current loss affected region map (LARM_{c}) is generated comprising values configured to indicate a level of quality for each macroblock in the current video frame, and at 740, a quality corruption metric is generated for the video transport stream based on the values in the LARM_{c}.

In one example, LARM_{c} values are based on a current activity region map. A current activity region map is generated comprising values configured to indicate a level of motion for each macroblock in the current video frame. Furthermore, for each macroblock in the current video frame it is determined if the macroblock is in an active region or in a static region of the current video frame based on the current activity region map. For each macroblock in the current video frame it is determined whether the macroblock has been lost, and in response to determining that a macroblock has been lost, generating the LARM_{c} by setting a value in the LARM_{c} indicating the lost macroblock is in the active region, and otherwise setting a value in the LARM_{c} indicating the lost macroblock is in the static region.

When a macroblock has been lost the associated motion compensation information is also lost and the current activity region map has to be generated with this in mind. The current activity region map is generated by determining for each macroblock in the current video frame whether the macroblock has been lost, and in response to determining that a macroblock has been lost, setting a motion compensation value in the current activity region map for the lost macroblock that corresponds to a level of motion compensation in a neighboring macroblock.

In another example, LARM_{c} values are based on a reference loss affected region map. The video transport stream is decoded to produce a reference video frame. A reference loss affected region map is generated that is configured to indicate lost macroblocks in the reference video frame. For each macroblock in the current video frame it is determined whether the macroblock has been received, and in response to determining that a macroblock has been received, it is determined if the received macroblock is predicted from a lost macroblock or from a reference macroblock in the reference video frame based on the reference loss affected region map. The LARM_{c} is generated by setting a value in the LARM_{c} indicating the received macroblock is propagating an error in the active region, and otherwise a value is set in the LARM_{c} indicating the received macroblock is propagating an error in the static region.

The values in the current activity region map may also be based on values in a reference activity region map. A reference activity region map is generated that is configured to indicate a level of motion compensation for each macroblock in the reference video frame. For each macroblock in the current video frame it is determined whether the macroblock has been lost, and in response to determining that the macroblock has been lost, a motion compensation value is set in the current activity region map for the lost macroblock that corresponds to a level of motion compensation in a corresponding macroblock in the reference activity region map.

In another example, values in the current activity region map may be based on values associated within a window of macroblocks located or positioned around a given macroblock. This method may be used, for example, when a corresponding macroblock in the reference activity region map has also been lost. A reference activity region map is generated that is configured to indicate a level of motion compensation for each macroblock in the reference video frame. For each macroblock in the current video frame it is determined whether the macroblock has been lost. In response to determining that a macroblock has been lost, a window is defined of macroblocks in the reference activity region map positioned about a macroblock corresponding to the lost macroblock and a motion compensation value is set in the current activity region map for the lost macroblock that corresponds to a level of motion compensation in the window of macroblocks in the reference activity region map.

Once the QCM has been generated, it can be used for network monitoring and control. The QCM can also be used by encoders to adjust encoding parameters used to encode the transport stream.

Referring to FIG. 8, a specific example of the operations performed at 720, 730, and 740 of the flow chart shown in FIG. 7 for the decoder based QCM generation process logic 700 will now be described. At 805, the QCM is reset to zero. At 810, the ARM_{c} and LARM_{c} are reset or otherwise cleared, the ARMₚ and LARMₚ are updated with any new information received from the encoder, and the current frame is decoded. At 815, a determination is made as to whether the next macroblock, MB(m, n), been received. If not, at 820, ARM_{c}(m, n) is calculated according to MB(m, n)'s decoded spatiotemporal neighbors. When MB(m, n) has not been received, i.e., lost, there is no way of telling whether or not MB(m, n) is in the active or static region because the associated motion information has also been lost. In this case it is logical to look at MB(m, n)'s spatiotemporal neighbors since they are likely to have similar motion vectors as MB(m, n). A range or window of macroblocks about MB(m, n) may be examined. The macroblocks in the window may be averaged to determine if MB(m, n) is in the active region.

For each lost macroblock, first its neighbors in the current frame are examined. If any of its correctly received neighbors in current frame have ARM_{c} set to 1, then set ARM_{c}(m, n) equal to 1. Otherwise, look at a window of macroblocks in the previous frame ARMₚ using a predetermined range of macroblocks W_arm, i.e., from (m−W_arm, n−W_arm) to (m+W_arm, n+W_arm), to count for the motion extrapolation from previous frame. For each MB(p, q) in this window, if their corresponding motion vectors (MV_x, MV_y) projection will put the respective macroblock into the position of MB(m, n), e.g., m*16≦(p*16−MV_x)<(m+1)*16, or n*16≦(q*16−MV_y)<(n+1)*16, then set ARM_{c}(m, n) equal to 1.

In another example, one could use the corresponding value in an ARMₚ, or the range of values ARMₚ(p, q) within the ARMₚ without checking the motion compensation vectors. If any of the values in ARMₚ(p, q) is equal to 1, set ARM_{c}(m, n) equal to 1, and otherwise set the value of ARM_{c}(m, n) equal to 0. The default value of the window size of W_arm may be set to an integer value. The larger the value of W_arm, the larger the motion range that can be taken into account, but this comes with an increased computational cost.

In a special case, if the lost macroblock is in the first P-frame after an I-frame (or instantaneous decoder refresh (IDR) frame), the activity map from the previous frame ARMₚ (which is the I-frame) is all zeroes. In this case, only if all of the lost macroblock's correctly received neighbors in ARM_{c} have a value of 0, then ARM_{c}(m, n) is set equal 0. Otherwise, set ARM_{c}(m, n) equal to 1.

At 825, ARM_{c}(m, n) is checked to see if it is equal to 0 indicating that MB(m, n) is in the static region. If so, at 830, LARM_{c}(m, n) is set to the value LOST_IN_STATIC_REGION. Otherwise, at, 835, LARM_{c}(m, n) is set to the value LOST_IN_ACTIVE_REGION. At 870, the QCM is an accumulation of the quality corruption values (QCVs) contained in LARM_{c}(m, n), i.e., QCM=ΣQCV[LARM_{c}(m, n)].

Referring again to decision point 815, if MB(m, n) has been received, then at 840, ARM_{c}(m, n) is calculated according to MB(m, n)'s motion vectors. In one example, if the sum of the absolute values of the MB(m, n)'s motion vectors is greater than a predefined “active” threshold, designated T_act, then MB(m, n) is considered to be in the active region and ARM_{c}(m, n) is set to one. At 845, LARMₚ of MB(m, n)'s predictors, i.e., macroblocks that MB(m, n) is being predicted from, are checked for values greater than zero indicating lost macroblocks in the reference frame. If the LARMₚ's are not greater than zero, then at 850, m and n are updated and decoding continues at 815.

If the LARMₚ's are greater than zero, then at 855, ARM_{c}(m, n) is checked to see if it is equal to 0 indicating that MB(m, n) is in the static region. If so, at 860, LARM_{c}(m, n) is set to the value PROP_IN_STATIC_REGION. Otherwise, at, 865, LARM_{c}(m, n) is set to the value PROP_IN_ACTIVE_REGION. At 870, the QCM is accumulated as described previously.

At 880, the end of frame (EOF) is checked. If EOF is not reached then at 850, m and n are updated and decoding continues at 815. If EOF is reached then at 885, a determination is made as to whether the received frame was a correctly received I-frame. If so, the QCM is reset and decoding for the next frame continues at 810. Otherwise, the QCM maintains its value and decoding for the next frame continues at 810. Thus, the QCM will continue to accumulate QCVs until the next intra frame is received. The values in ARM_{c} and LARM_{c} may be saved in an ARMₚ and a LARMₚ, respectively, for future frames. The values in the LARMs may be quantized or thresholded in order to eventually generate a QCM with the desired characteristics. Example default parameters for process 700 are shown in Table 1.

TABLE 1

| | | Default |
|---|---|---|
| Parameter Name | Symbol | Value |
| Threshold to define active | T_act | 0 |
| region | | |
| Threshold to define the motion | W_arm | 2 |
| projection window | | |
| Quality corruption value for a | QCV[LOST_IN_ACTIVE_REGION] | 2 |
| lost macroblock in the active | | |
| region | | |
| Quality corruption value for a | QCV[LOST_IN_STATIC_REGION] | 0 |
| lost macroblock in the static | | |
| region | | |
| Quality corruption value for | QCV[PROP_IN_ACTIVE_REGION] | 1 |
| error propagation in the active | | |
| region | | |
| Quality corruption value for | QCV[PROP_IN_STATIC_{——}REGION] | 0 |
| error propagation in the static | | |
| region | | |

Referring now to FIG. 9, a flowchart generally depicting the statistics-based QCM generation process logic 900 will now be described. At 910, at a device in a network, a data stream is received that encapsulates a video transport stream comprising one or more video frames. At 920, a data loss rate is generated for the current video frame based on information contained in the data stream. At 930, a first statistical ratio is computed that consists of an active number of pixels of the current video frame to a total number of pixels of the current video frame. At 940, a second statistical ratio is computed that consists of a number of pixels of the current video frame that have an error propagated from a reference video frame to a number of pixels of a reference video frame that have been lost or that have propagated error. At 950, a quality corruption metric is generated by computing an arithmetic combination of the data loss rate, the first statistical ratio, and the second statistical ratio.

In one example, a third statistical ratio may be incorporated into the QCM. A third statistical ratio is computed that consists of a number of macroblocks in the current video frame that are coded in intra mode to a total number of macroblocks in the current video frame. The quality corruption metric is generated by computing an arithmetic combination of the data loss rate, the first statistical ratio, the second statistical ratio, and the third statistical ratio. The data loss rate and the statistical ratios may be computed using actual video frame data, i.e., computed frequently or may be empirically derived by collecting data over time depending on system requirements.

In another example, the data stream comprises RTP packets, in which case generating the data loss rate is based on information contained in an RTP payload header. Feedback may be sent from the decoder to various devices in the network using, an e.g., Real-time Transport Control Protocol (RTCP) flow or another control protocol now known or hereinafter developed. The data loss rate, and the first statistical and second statistical ratios may be sent in the RTCP flow, e.g., using application specific features of RTCP. The device receiving the RTCP flow can extract the data loss rate and the statistical ratios from the received RTCP flow to locally generate the QCM. Once the QCM has been generated, it can be used for network monitoring and control, and by the encoder to adjust encoding parameters used to encode the transport stream.

Referring to FIG. 10, a specific example of the operations 920-950 of the flow chart shown in FIG. 9 for the statistics-based QCM generation process logic 900 will now be described. At 1010, the QCM and an interim quality control metric (gcmᵢ) are reset to zero, where the variable i is the frame index. At 1020, the RTP header is parsed for RTP packets received at the device. At 1030, it is determined if a full I-frame has been received based on the RTP header information. The stream reader can use the Sequence Number (SN), Time Stamp (TS) and Marker bit (M) in the RTP header to determine the boundaries of the video frames. If a full I-frame has been received, at 1035, the QCM and the interim gcmᵢ are reset to zero. At 1080, the frame index i is updated and the process continues at 1020.

If a full I-frame has not been received, then at 1040, the data loss rate for the current frame is calculated based on RTP header information. The data loss rate for i-th frame can be denoted as pᵢ. At 1050, the qcmᵢ for the current frame is calculated using a recursive model. An example of a recursive model is as follows.

A first statistical ratio α is calculated, (0≦α≦1), where α is an active number of pixels of the current video frame to a total number of pixels of the current video frame. For the worst case scenario a value of 1 can be used. A second statistical ratio β is calculated, (β≧0), where β is a number of pixels of the current video frame that have an error propagated from a reference video frame to a number of pixels of a reference video frame that have been lost or have propagated error. For the worst case scenario a value of 2 can be used. A third statistical ratio γ is calculated, (0≦γ≦1), where γ is a number of macroblocks in the current video frame that are coded in intra mode to a total number of macroblocks in the current video frame. For the worst case scenario a value of 0 can be used. The total number of MBs per frame is defined as T. The estimated number of MBs that got corrupted for i-th frame is defined as Nᵢ. The quality corruption metric for i-th frame is defined as qcmᵢ, where qcmᵢ=Nᵢ/T. The overall quality corruption metric for all the frames is defined as QCM, where QCM=Σqcmᵢ.

A recursive function is then derived. The recursion starts from the first loss observed after a correctly received IDR frame such that:

N₀=α×T×p₀

Nᵢ=β×Nᵢ₋₁+α×(T×β×Nᵢ₋₁)×pᵢ−γ×β×Nᵢ₋₁×(1−pᵢ)=β×(1−γ−α×pᵢ+γ×pᵢ)+α×pᵢ×T (Eqs. 1)

where β×Nᵢ₋₁ is the number of macroblocks that might be affected due to error propagation, α×(T×β×Nᵢ₋₁)×pᵢ is the number of active macroblocks in the frame that are affected only due to the loss in current frame, and γ×β×Nᵢ₋₁×(1−pᵢ) is the number of macroblocks that are actually intra updated within the region that otherwise is affected by the error propagation.

At the RTP level, the total number of macroblocks per frame T is unknown. However, in Eqs. 1 the T term cancels out by way of substituting the recursive term qcmᵢ₋₁ to derive Eqs. 2 below. Hence, the quality corruption metric for i-th frame qcmᵢ is as follows:

qcm₀=α×p₀

qcmᵢ=β×(1−γ−α×pᵢ+γ×pᵢ)×qcmᵢ₋₁+α×pᵢ (Eqs. 2)

The overall quality corruption metric through the n-th frame is defined as the sum of all the interim quality corruption metrics for each frame:

$${QCM}_{n} = {\sum }_{i = 0}^{n} {qcm}_{i} \qquad ( Eq . 3 )$$

Note that it is possible that the picture quality recovers from the loss effects through the gradual intra update. At 1060, suppose the intra update happens at frame m and qcmᵢ=0, where i=m. The overall quality corruption metric QCM needs to be reset under such conditions and the recursion can be restarted. The QCM is reset at 1065 when qcmᵢ is equal to zero. At 1070, the QCM is accumulated by the qcmᵢ value. At 1080, the frame index is incremented and the process repeats for the next frame. It should be noted that in addition to the QCM, individual qcmᵢ's or a weight average of qcmᵢ's may also be used to determine quality corruption.

Example default parameters for process 900 are shown in Table 2.

TABLE 2

| | | Default |
|---|---|---|
| Parameter Name | Symbol | Value |
| Statistical ratio of the active region within | α | 0.5 |
| a frame | | |
| Statistical ratio of the error propagation | β | 1.2 |
| effect from one frame to another | | |
| Statistical ratio of the intra MB update for | γ | 0 |
| each frame within the bitstream | | |

Techniques are provided herein for generating non-reference based quality corruption metrics. The metrics are generated from decoded video information or computed from statistics gathered throughout a lossy network. Both a general method and specific examples have been described.

The above description is intended by way of example only.

What is claimed is:

1. A method comprising:
receiving at a device in a network a data stream encapsulating a video transport stream comprising one or more video frames;
decoding the video transport stream to produce a current video frame;
generating a current loss affected region map comprising values configured to indicate a level of quality for each macroblock in the current video frame; and
generating a quality corruption metric for the video transport stream based on the values in the current loss affected region map.

2. The method of claim 1, further comprising:
generating a current activity region map comprising values configured to indicate a level of motion compensation for each macroblock in the current video frame;
determining for each macroblock in the current video frame if the macroblock is in an active region or in a static region of the current video frame based on the current activity region map;
determining for each macroblock in the current video frame whether the macroblock has been lost;
wherein in response to determining that a macroblock has been lost, generating the current loss affected region map comprise setting a value in the current loss affected region map indicating the lost macroblock is in the active region, and otherwise setting a value in the current loss affected region map indicating the lost macroblock is in the static region.

3. The method of claim 2, wherein generating the current activity region map comprises:
determining for each macroblock in the current video frame whether the macroblock has been lost; and
in response to determining that a macroblock has been lost, setting a motion compensation value in the current activity region map for the lost macroblock that corresponds to a level of motion compensation in a neighboring macroblock.

4. The method of claim 1, further comprising:
decoding the video transport stream to produce a reference video frame;
generating a reference loss affected region map configured to indicate lost macroblocks in the reference video frame;
determining for each macroblock in the current video frame whether the macroblock has been received;
in response to determining that a macroblock has been received, determining if the received macroblock is predicted from a lost macroblock or from a reference macroblock in the reference video frame based on the reference loss affected region map; and
wherein generating the currently loss affected region map comprises setting a value in the current loss affected region map indicating the received macroblock is propagating an error in the active region, and otherwise setting a value in the current loss affected region map indicating the received macroblock is propagating an error in the static region.

5. The method of claim 4, further comprising:
generating a reference activity region map configured to indicate a level of motion compensation for each macroblock in the reference video frame;
determining for each macroblock in the current video frame that the macroblock has been lost; and
in response to determining that the macroblock has been lost, setting a motion compensation value in the current activity region map for the lost macroblock that corresponds to a level of motion compensation in a corresponding macroblock in the reference activity region map.

6. The method of claim 4, further comprising:
generating a reference activity region map configured to indicate a level of motion compensation for each macroblock in the reference video frame;
determining for each macroblock in the current video frame whether the macroblock has been lost; and
in response to determining that a macroblock has been lost, defining a window of macroblocks in the reference activity region map positioned about a macroblock corresponding to the lost macroblock and setting a motion compensation value in the current activity region map for the lost macroblock that corresponds to a level of motion compensation in the window of macroblocks in the reference activity region map.

7. The method of claim 1, further comprising sending feedback using Real-time Transport Control Protocol (RTCP) flow to an encoding device configured to transmit the data stream, and further comprising at the encoding device:
extracting a data loss rate for the current video frame from the RTCP flow;
extracting a first statistical ratio of an active number of pixels of the current video frame to a total number of pixels of the current video frame from the RTCP flow;
extracting a second statistical ratio of a number of pixels of the current video frame that have an error propagated from a reference video frame to a number of pixels of a reference video frame that have been lost or have propagated error from the RTCP flow; and
generating a statistics-based quality corruption metric by computing an arithmetic combination of the data loss rate, the first statistical ratio, and the second statistical ratio.

8. The method of claim 7, further comprising, at the encoder device, adjusting encoding parameters used to encode the transport stream based on the statistics-based quality corruption metric.

9. A method comprising:
receiving at a device in a network a data stream encapsulating a video transport stream comprising one or more video frames;
generating a data loss rate for the current video frame based on information contained in the data stream;
computing a first statistical ratio of an active number of pixels of the current video frame to a total number of pixels of the current video frame;
computing a second statistical ratio of a number of pixels of the current video frame that have an error propagated from a reference video frame to a number of pixels of a reference video frame that have been lost or have propagated error; and
generating a statistics-based quality corruption metric by computing an arithmetic combination of the data loss rate, the first statistical ratio, and the second statistical ratio.

10. The method of claim 9, further comprising:
computing a third statistical ratio of a number of macroblocks in the current video frame that are coded in intra mode to a total number of macroblocks in the current video frame, wherein generating the quality corruption metric comprises computing an arithmetic combination of the data loss rate, the first statistical ratio, the second statistical ratio, and the third statistical ratio.

11. The method of claim 9, wherein the data stream comprises Real-time Transport Protocol (RTP) packets, and wherein generating the data loss rate is based on information contained in an RTP payload header.

12. The method of claim 9, further comprising sending feedback comprising the data loss rate and statistical ratios using a control protocol to an encoding device configured to transmit the data stream.

13. The method of claim 12, further comprising, at the encoder device, adjusting encoding parameters used to encode the transport stream based on the quality corruption metric.

14. An apparatus comprising:
a network interface unit configured to receive a data stream encapsulating a video transport stream comprising one or more video frames;
a decoder configured to decode the video transport stream to produce a current video frame;
a processor configured to:
generate a current loss affected region map comprising values configured to indicate a level of quality for each macroblock in the current video frame; and
generate a quality corruption metric for the video transport stream based on the values in the current loss affected region map.

15. The apparatus of claim 14, wherein the processor is further configured to:
generate a current activity region map comprising values configured to indicate a level of motion compensation for each macroblock in the current video frame;
determine for each macroblock in the current video frame if the macroblock is in an active region or in a static region of the current video frame based on the current activity region map;
determine for each macroblock in the current video frame whether the macroblock has been lost;
wherein in response to determining that a macroblock has been lost, the processor is configured to generate the current loss affected region map by setting a value in the current loss affected region map indicating the lost macroblock is in the active region, and otherwise setting a value in the current loss affected region map indicating the lost macroblock is in the static region.

16. The apparatus of claim 15, wherein the processor is further configured to:
determine for each macroblock in the current video frame whether the macroblock has been lost; and
in response to determining that a macroblock has been lost, set a motion compensation value in the current activity region map for the lost macroblock that corresponds to a level of motion compensation in a neighboring macroblock.

17. The apparatus of claim 14, wherein the processor is further configured to:
decode the video transport stream to produce a reference video frame;
generate a reference loss affected region map configured to indicate lost macroblocks in the reference video frame;
determine for each macroblock in the current video frame whether the macroblock has been received;
in response to determining that a macroblock has been received, determine if the received macroblock is predicted from a lost macroblock or from a reference macroblock in the reference video frame based on the reference loss affected region map, and generate the current loss affected region map by setting a value in the current loss affected region map indicating the received macroblock is propagating an error in the active region, and otherwise setting a value in the current loss affected region map indicating the received macroblock is propagating an error in the static region.

18. The apparatus of claim 17, wherein the processor is further configured to:
generate a reference activity region map configured to indicate a level of motion compensation for each macroblock in the reference video frame;
determine for each macroblock in the current video frame that the macroblock has been lost; and
in response to determining that the macroblock has been lost, set a motion compensation value in the current activity region map for the lost macroblock that corresponds to a level of motion compensation in a corresponding macroblock in the reference activity region map.

19. The apparatus of claim 17, wherein the processor is further configured to:
generate a reference activity region map configured to indicate a level of motion compensation for each macroblock in the reference video frame;
determine for each macroblock in the current video frame whether the macroblock has been lost; and
in response to determining that a macroblock has been lost, define a window of macroblocks in the reference activity region map positioned about a macroblock corresponding to the lost macroblock and set a motion compensation value in the current activity region map for the lost macroblock that corresponds to a level of motion compensation in the window of macroblocks in the reference activity region map.

20. A processor readable medium storing instructions that, when executed by a processor, cause the processor to:
generate a current loss affected region map comprising values configured to indicate a level of quality for each macroblock in a current video frame of a decoded video transport stream encapsulated in a data stream; and
generate a quality corruption metric for the video transport stream based on the values in the current loss affected region map.

21. The processor readable medium of claim 20, and further comprising instructions that, when executed by a processor, cause the processor to:
generate a current activity region map configured to indicate a level of motion compensation for each macroblock in the current video frame;
determine for each macroblock in the current video frame if the macroblock is in an active region or in a static region of the current video frame based on the current activity region map;
determine for each macroblock in the current video frame whether the macroblock has been lost;
in response to determining that a macroblock has been lost, the instructions that cause the processor to generate the current loss affected region map comprise instructions that cause the processor to set a value in the current loss affected region map indicating the lost macroblock is in the active region, and otherwise setting a value in the current loss affected region map indicating the lost macroblock is in the static region.

22. The processor readable medium of claim 20, and further comprising instructions that, when executed by a processor, cause the processor to:
decode the video transport stream to produce a reference video frame;
generate a reference loss affected region map configured to indicate lost macroblocks in the reference video frame;
determine for each macroblock in the current video frame whether the macroblock has been received;
in response to determining that a macroblock has been received, determine if the received macroblock is predicted from a lost macroblock or from a reference macroblock in the reference video frame based on the reference loss affected region map, and wherein the instructions that cause the processor to generate the current loss affected region map comprise instructions that cause the processor set a value in the current loss affected region map indicating the received macroblock is propagating an error in the active region, and otherwise set a value in the current loss affected region map indicating the received macroblock is propagating an error in the static region.
